(19) United States
(12) Patent Application Publication
(10) Pub. No.: US 2009/0155023 A1
(43) Pub. Date: Jun. 18, 2009

(54) Bale Handling Apparatus and Method

(75) Inventor: Benoit Bernier, Pintendre (CA)

Correspondence Address: SUTHERLAND ASBILL & BRENNAN LLP, 999 PEACHTREE STREET, N.E., ATLANTA, GA, 30309, US

(73) Assignee: LES EQUIPMENTS WILBE INC., Pintendre, QC (CA)

(21) Appl. No.: 12/097,720

(22) PCT Filed: Dec. 16, 2005
(86) PCT No.: PCT/CA05/01924

§ 371 Date: Oct. 3, 2008

(51) Int. Cl. A01D 87/12; A01D 87/00

(52) U.S. Cl. 414/24.5

(57) ABSTRACT

A bale handling apparatus (12 or 14) having at least two cooperating flaps (46, 47), each flap defining a free longitudinal edge and an opposite edge longitudinally hinged about a support member (34), the flaps being pivotable between a closed position where each edge points the edge of the other flap and where the flaps can cooperate in lifting a bale engaged between the flaps upon elevating the support members, and an open position where the bale is substantially freed from the flaps to allow longitudinal disengagement of the flaps from the bale. The bale handling method includes at least the freeing of at least one bale which includes lowering two cooperating flaps in a closed position, the flaps sustaining a bale engaged therebetween, until the bale touches the ground; pivoting the cooperating flaps into an open position to substantially free the bale from the flaps; and longitudinally disengaging the pivoted flaps from the bale.

### TECHNICAL FIELD

The invention relates generally to the handling of bales in the agricultural industry, and more specifically, the invention presents new and useful apparatuses and method for handling bales.

### BACKGROUND

The handling of bales has been a subject of innovation for many decades. Many considerations warrant the production of large bales, but the larger the bale, the heavier it is and the harder it is to handle. In the past years, many bale handling apparatuses adapted to handle round bales (i.e. bales of a cylindrical shape) were devised which were adapted to move round bales from the point where they were formed to the point where they are stored.

Applicant believes there remains a need in the art for improved bale handling apparatuses and methods.

### SUMMARY

Accordingly, an object of the present invention is to provide an apparatus and/or a method adapted for handling bales which overcomes at least some of the inconveniences of the prior art.

Another object of the invention is to provide an wheel system which can elevate and lower a wagon and provide stability when driving the wagon on uneven terrain.

In accordance with one embodiment, the invention provides a bale handling apparatus having at least two parallel support members separated by a distance which generally corresponds to a major dimension of a bale to handle, the bale handling apparatus being characterized in that each support member has a flap defining a longitudinal edge, the flaps being pivotable between a closed position where each edge points the edge of the other flap and where the flaps can cooperate in lifting a bale engaged between the flaps upon elevating the support members, and an open position where the bale is substantially freed from the flaps to allow longitudinal disengagement of the flaps from the bale.

In accordance with an other embodiment, the invention provides a method of handling a bale comprising freeing at least one bale including: lowering two cooperating flaps in a closed position, the flaps sustaining a bale engaged therebetween, until the bale touches the ground; pivoting the cooperating flaps into an open position to substantially free the bale from the flaps; and longitudinally disengaging the pivoted flaps from the bale.

In accordance with one embodiment, the method further comprises: lifting at least one bale including: pivoting the cooperating flaps on the support members into an open position; lowering the support members with the flaps in open position alongside the bale; pivoting the flaps of the lowered support members into a closed position with the bale engaged therebetween; and raising the support members and the two cooperating flaps in closed position with the flaps sustaining the engaged bale, thus lifting the bale.

In accordance with one embodiment of the method, the cooperating flaps are pivoted by the bale.

In accordance with an other embodiment, the invention provides a bale handler comprising: a mobile frame including at least a pair of parallel spaced apart support members, the support members capable of being jointly raised and lowered, and defining a bale reception area therebetween; at least two cooperating flaps, one on each member, each flap having a free edge and being upwardly pivotable between a closed position of the flaps in which each flap extends towards the bale reception area, whereby the cooperating flaps can engage and support the weight of at least one bale, and an open position where the bale is substantially free from the flaps.

In accordance with one embodiment, the flaps are hingedly mounted along the support members and are free to pivot upwardly from the closed position, and a stopper is provided to prevent the flap from pivoting downwardly from the closed position even under pressure from the weight of a bale.

In accordance with one embodiment, the flap and the stopper form an L shaped shutter in cross section being hingedly mounted to the respective support member, the stopper preventing said downward pivoting by abutting against the support member. In a more specific embodiment, a reinforcing plate is used to join the flap to the stopper. In another more specific embodiment, the shutter includes at least one fin longitudinally defined along the shutter, between the flap and the stopper. The fin cooperates with the bale upon lowering of the support members in pivoting the shutter upwardly to the open position of the flap. In accordance with one embodiment, the flaps are freely pivotable into the open position, and each flap includes one or more fins longitudinally disposed along the flap and being defined at an angle downwardly oriented from the flap in a manner that an engaged bale pivots the flaps towards the open position upon lowering of the flaps along the sides of the bale, and that the fins subsequently further pivot the flaps towards the open position by engagement with the bale.

In accordance with one embodiment, the support members have a free end and a fixed end, and wherein the flaps can longitudinally engage a bale therebetween from the free end towards the fixed end. In accordance with a more specific embodiment, the edges of the flaps define a cycloid shape to minimize damage to the bale from longitudinal disengagement therefrom. In accordance with an other more specific embodiment, at least one of the ends of the flaps where the bales are to be engaged and the free ends of the support members are of slanted configuration to ease longitudinal engagement of the bales. In accordance with an other more specific embodiment, the free end of at least one of the support members has a roller to guide the engagement of a bale. The above features can be combined in a number of different combinations.

In accordance with another embodiment, at least two cooperating flaps are connected to one another by a linkage, the linkage maintaining an inversely corresponding pivoting angle of the two cooperating flaps. In one embodiment, the bale handler further includes means for linking the cooperating flaps together in a manner for maintaining the angle of the first cooperating flap a mirror image of the angle of the second cooperating flap along a mirror plane defined perpendicularly, halfway between the first and second cooperating flaps.

In accordance with one embodiment, the bale handling apparatus is a fork for lifting and transporting individual bales. In one more specific embodiment, the fork includes an attachment rod having a hook, the attachment rod being connected to the fixed end of the support members and oriented perpendicularly from the support members; the hooks being adapted to engage the fork onto a manipulating component of a tractor. In accordance with one other more specific embodiment, the fork further includes at least one support rod connected to the fixed end of the support members and oriented perpendicularly from the support members, whereby the support rod limits the relative horizontal displacement of the bale with respect to the fork. In accordance with another embodiment, the bale handler is a fork with the frame and tines of the fork defining the support members, and mounting the cooperating flaps, wherein the frame of the fork connects a fixed end of each support members together with the support members being cantilevered, the frame having means for both tines to be jointly raised and lowered upon manipulation of the frame.

In accordance with one embodiment, the bale handling apparatus defines a wagon including a wagon frame connecting the support members together.

In accordance with an other embodiment, the invention provides a tandem wheel system including a first and a second wheels, the first and the second wheel each having its axle pivotally connected to a common shaft by a first and a second link members, respectively, each link member having an extension being defined away from an imaginary axis connecting the wheel axle to the shaft, the extension of the first link member being connected to the extension of the second link member by an extending member for pulling and pushing the extensions towards and away from each other, whereby the shaft is elevated and lowered by the pulling and pushing action of the extending member of the tandem wheel system.

In the embodiments of the invention where the bale handling apparatus is a wagon, the tandem wheel system can advantageously be used on the wagon.

### BRIEF DESCRIPTION OF THE DRAWINGS

Further features and advantages of the present invention will become apparent from the following detailed description, taken in combination with the appended drawings, in which:

FIG. 1 is a perspective view of bale handling apparatus in accordance with the invention namely a fork and a wagon;

FIG. 2 is a perspective view of the fork of FIG. 1, in accordance with one embodiment of the invention;

FIG. 3A is a perspective view, enlarged, of a tine of the fork of FIG. 2, with flaps shown in a closed position.

FIG. 3B is a perspective view of the tine of FIG. 3A, with the flaps shown in an open position.

FIGS. 4A to 4F are schematic views of successive steps of a method of handling bales in accordance with another embodiment of the invention;

FIG. 5 is a perspective view of the wagon of FIG. 1, in accordance with an other embodiment of the invention;

FIG. 6A is a rear elevation of the wagon of FIG. 5 showing the linkage mechanism in a closed position;

FIG. 6B is a rear elevation of the wagon of FIG. 6A, with the linkage in an open position;

FIG. 7A is a side elevation of a wheel assembly of the wagon of FIG. 5 in accordance with another embodiment of the invention, shown in elevated position;

FIG. 7B is a side elevation of the wheel assembly of FIG. 7A, shown in lowered position.

It will be noted that throughout the appended drawings, like features are identified by like reference numerals.

### DETAILED DESCRIPTION

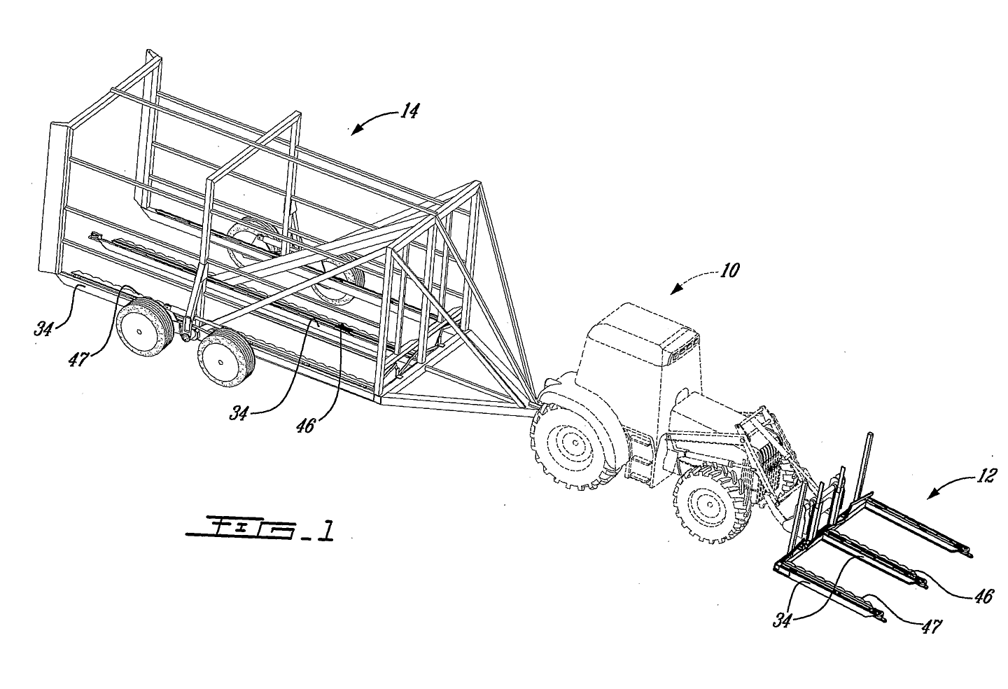

Turning now to the figures, and more specifically to FIG. 1, one can see a tractor 10 for operating both a fork 12, and a wagon 14. As will be shown and described herein, the “bale handling apparatus” includes one or the other. In these embodiments, it will be seen that the general design of the bale handling apparatuses 12 and 14 is particularly well adapted for the manipulation of “square” bales (i.e. bales of rectangular prism shape).

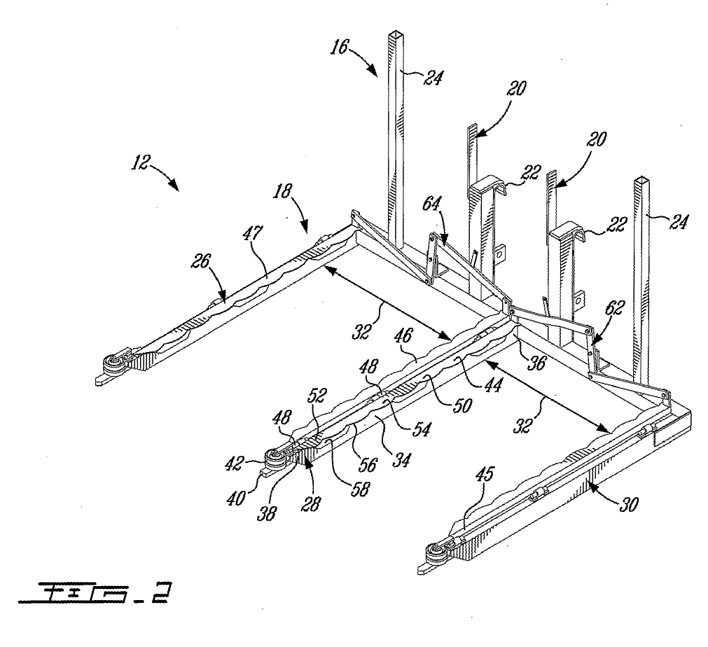

Turning to FIG. 2, a fork 12 for handling bales is shown, in accordance with one embodiment of the invention. The fork 12 is seen to generally include two main portions: a vertical portion 16 and a horizontal portion 18. The vertical portion 16 has the function of securing the fork 12 to a predetermined type of tractor 10 and may thus be modified in many ways as will be understood by those skilled in the art. In this embodiment, the fork 12 is symmetrical, and each symmetric side has an attach rod 20 including a hook 22 for engaging a manipulating component of the tractor 10 (FIG. 1), and a support rod 24 designed to support mounted bales horizontally. The horizontal portion 18 includes at least two tines which are used to handle and lift the bales. The number of tines and the spacing between them is dictated by the size, shape, and number of bales which are desired to be manipulated or transported together. In this embodiment, the horizontal portion 18 includes three tines 26, 28, 30, including two outer tines 26, 30 and one inner tine 28. The three tines 26, 28, 30 are on a common horizontal plane, are parallel, and are distanced from one another by a separation distance 32. When the fork 12 is in use, each two adjacent tines (26 and 28, or 28 and 30) cooperate in handling a bale. Although they differ in some aspects, the tines 26, 28, 30, generally include the same components, therefore, only the inner tine 28 needs to be described thoroughly.

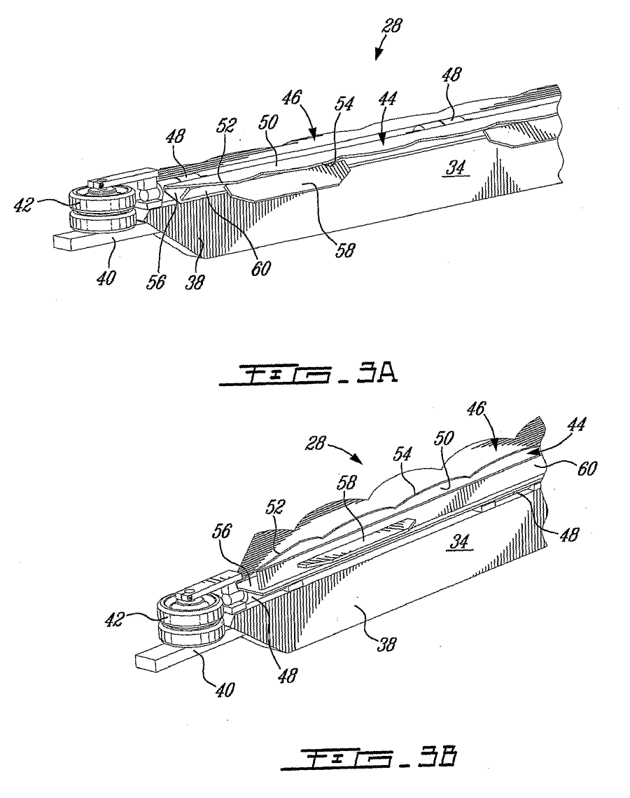

The inner tine 28 includes a support member 34 which is elongated and has two opposed ends: a fixed end 36 affixed to the vertical portion 16, and a free end 38 extending away from the vertical portion 16. For illustration purposes, the support member 34 can be made of a rectangular rod having 1.5″ wide and 6″ high, for example. The free end 38 of the support member 34 is preferably sloped for it to slide more smoothly against the ground if it accidentally contacts it when the fork 12 longitudinally engaged a bale or bales. A prong 40 extends from the free end 38, and optionally receives a roller 42 which guides the bales and facilitates the entry of the bales between the tines 26, 28, 30 of the fork 12. This is more clearly depicted in FIGS. 3A and 3B where it is also seen that two similar shutters 44, 46 are hingedly mounted to the upper side of the support member 34 via hinges 48. The left side shutter 44 generally faces the left side tine 30, and the right side shutter 46 generally faces the right side tine 26 (FIG. 2). In this embodiment, each shutter 44, 46 is a mirror image of the other, and therefore only one needs to be described thoroughly.

The left side shutter 44 can be seen to include a flap 50. In this embodiment, the flap 50 is made of a flat material of a length generally corresponding to the length of the support member 34, and of a width to be predetermined as a function of the types of bales to be handled. The thickness of the flap 50 is to be determined by structural considerations, depending on the weight and the type of bale or pile of bales to be lifted, and is adapted to provide for lateral insertion within a bale, as will be discussed in further detail below. In this embodiment, the tip 52 of the flap 50 is slanted to ease longitudinal entry along the side of a bale, and the edge 54 of the flap 50 is of a cycloid shape. In FIG. 3A, the shutters 44, 46 are at rest, in a position which will be referred to as the closed position. In this closed position, the flap 50 lies in a plane substantially parallel to the plane along which the tines 26, 28, 30 are aligned, and the flap 50 extends from the hinges 48 towards the direction of the cooperating tine, which is tine 30 in the case of shutter 44 (see also FIG. 2).

In this embodiment, in addition to the flap 50, the shutter 44 also includes a stopper 56 which defines a cross-sectional L shape with the flap 50, and fins 58 which are in this case longitudinally spaced along the shutter 44. In the closed position illustrated in FIG. 3A, the weight of a bale upon the flap 50 acts to maintain the hinged shutters 44 pivoted about the hinges 48 and to keep the stopper 56 abutting against the support member 34. Preferably, the shutters 44 will also fall back into this closed position under their own weight. Thus, the stopper 56 serves to maintain the flaps 50 in the desired orientation when at rest. It will be understood by those skilled in the art that although this configuration provides some advantages, alternative configurations allow to achieve a similar purpose. For example, in an alternative embodiment (not illustrated), the upper face of the support member is flat, and the hinge is located substantially centrally onto the upper face, thus leaving a flat stopper portion of the upper face of the support member between the hinge and the side of the support member. Thereby, the flap is restrained from pivoting downwardly about the hinge by abutting against the stopper portion of the support member, and is thus maintained in closed position.

The fins 58 are optional. Their purpose is to assist in pivoting the shutter 44 into the open position (as depicted in FIG. 3B) under the influence of the bale, when the tines 26, 28, 30 (see FIG. 2) are lowered. In certain embodiments, they also serve to engage the bale when in closed position. In this embodiment, the fins 58 are soldered against a reinforcing plate 60 which is itself soldered between the flap 50 and the stopper 56. The reinforcing plate 60 increases the structural resistance of the flap 50. The pivoting action of the flaps 50 upon lowering of the tines 26, 28, 30 results in at least partly freeing the bale from cooperating flaps and in easing longitudinal retraction of the tines 26, 28, 30 from the bale.

Turning back to FIG. 2, it is seen that the left side outer tine 30, and the right side outer tine 26 only include one shutter (45 and 47, respectively) instead of two opposed shutters 44, 46 for the central inner tine 28. The shutter 45 of the left side tine 30 cooperates with the left side shutter 44 of the central tine 28 in handling a bale on the left hand side of the fork 12, whereas the shutter 47 of the right side tine 26 cooperates with the right side shutter 46 of the central tine 28 in handling a bale on the right hand side of the fork 12. One skilled in the art will understand that one can provide a fork 12 having only two tines, in which case the central inner tine 28 is simply omitted, and dimensions adapted, and alternatively one can provide a fork 12 having more than three tines by adding inner tines 28 in a regular array.

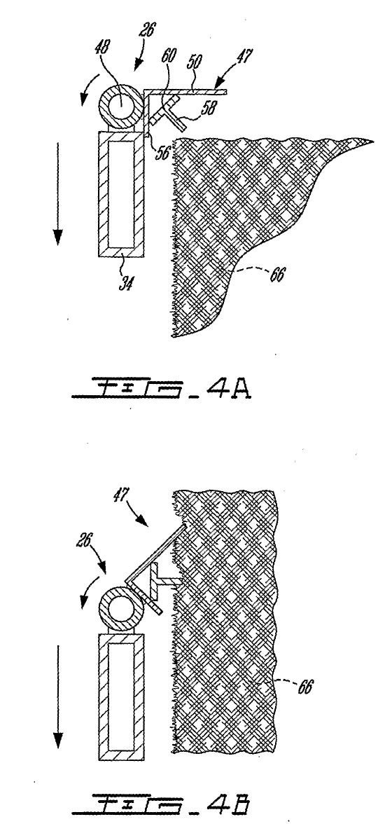

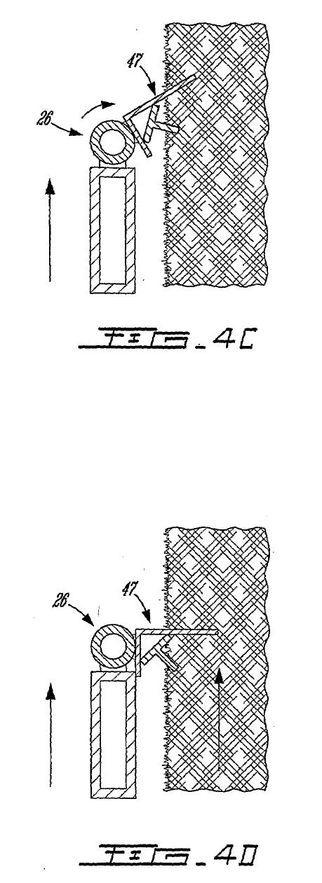

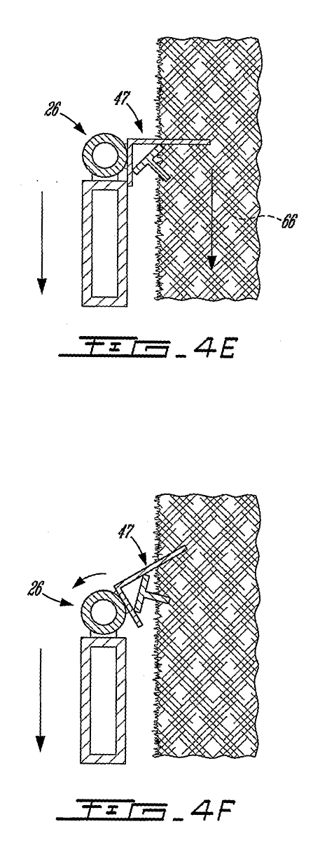

Turning now to FIGS. 4A to 4D, steps of one method for loading a bale with the fork 12 are depicted in sequence, in accordance with one embodiment of the invention. Only the right side outer tine 26 is depicted, but it is to be understood that the cooperating tine can readily be imagined as being a mirror image of the right side outer tine 26 on the opposite side of the bale 66. In FIG. 4A, the fork 12 (FIG. 2) is lowered onto a bale 66. The right side tine 26 is shown in closed position, with the shutter 47 pivoted down and the stopper 56 abutting the support member 34. Upon further lowering of the fork 12, and consequently lowering the tine 26 along the bale 66 into the position shown in FIG. 4B, the flap 50 and the fin 58 engage the bale 66, and the bale 66 forces the shutter 47 into open position, which allows the shutter 47 to slide along the edge of the bale 66. Alternatively, the flap 50 can be in open position before engaging the bale 66, and slide along the bale 66. The fork 12 is lowered with the tines 26, 28 on each side of the bale 66 until the shutters 46 and 47 are near the lower end of the bale 66 (see FIG. 2). The fork 12 is then stopped, and is then elevated to lift the bale 66. Turning to FIG. 4C, it is shown that the elevation of the tine 26 results in pivoting the shutter 47 back into the closed position, under the influence of the bale 66 which resists the movement of the shutter 47 from above, by its weight. When the shutter 47 is completely closed, as depicted in FIG. 4D, and the fork 12 (with tine 26) is further elevated, the bale 66 is lifted from the ground and can be carried.

Turning now to FIGS. 4E and 4F, it is seen how the bale 66 is removed from the fork 12 (see FIG. 2). The fork 12 is lowered until the bale 66 touches the ground. During this step, the shutter 47 remains in closed position under the weight of the bale 66 as it is depicted in FIG. 4E. Then, when the bale touches the ground, the fork 12 is lowered further, the tine 26 is consequently lowered beside the deposited bale 66, as depicted in FIG. 4F, and the deposited bale pushes the shutter 47 toward the open position. With the shutter 47 in the open position, the tractor 10 (see FIG. 1) backs up, thus retracting the tines 26 and 28 longitudinally from the opposed sides of bale 66. The fact that the shutters 47 and 46 are open helps the tines 26 and 28 to slide freely alongside the bale 66, substantially without damaging it. The cycloid shape of the edges 54 of the flaps 50 (FIG. 2) further contribute to the smooth retraction of the tines 26, 28.

As one skilled in the art will understand, it is possible when using a triple tine fork 12 as depicted and described above to load two bales disposed side by side at the same time, by inserting the central tine 28 between the two bales and placing the outer tines 26 and 30 on each outer side of the two bales. Forks with more than three tines will allow the loading of three or more bales in width. Further, piles of stacked bales can be picked up together. For example, if two stacks of two bales each are disposed side by side, the four bales can be handled as described above. Further still, if the length of the tines is sufficient to allow it, one can maneuver the fork to lift and carry more than one stack of bale deep.

In an alternative method of loading bales, the tractor 10 (see FIG. 1) advances with the fork lowered down, and pushes the tines including the flaps longitudinally alongside the bales. The use of a roller 42 to help align the bale with the tines, and the use of a support member 34 and a flap 50 with a slanted free end 38 and tip 52, respectively, as described above, contributes to easing this longitudinal insertion of the tines 26, 28, 30 alongside the bales with as little damage to them as possible. The cycloid shape of the edges 54 of the flaps 50 as described above further contributes to minimizing damage from the longitudinal entry. Once the tines 26, 28, 30 are in correct longitudinal position along the bales, the method is resumed as depicted in FIGS. 4D to 4F, and correspondingly described above.

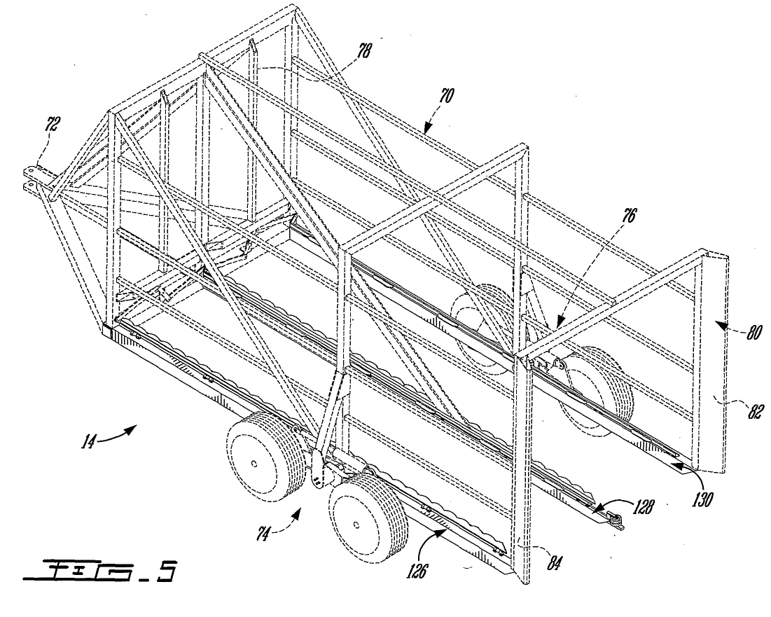

Turning now to FIG. 5, a wagon 14 for handling bales is depicted as an alternative embodiment of the invention. In this embodiment, the wagon 14 includes a frame 70 which is generally configured to give structural resistance to the wagon 14, to maintain bales mounted therein from falling off, and to securely connect the wagon 14 to the tractor 10 (FIG. 1) via a hitch 72. The wagon 14 can also be seen to include three rails 126, 128 and 130, which closely resemble the tines 26, 28, 30 of the fork 12 (FIG. 2) which were previously described, except for having a greater length, and will therefore not be further detailed. The left side rail 126 and the right side rail 130 are outer rails, whereas the central rail 128 is an inner rail. The wagon 14 also includes a left side tandem wheel system 74 and a right side tandem wheel system 76 which are mirror images of one another. Therefore, only one needs to be described below. The tandem wheel systems 74, 76 provide for elevating and lowering the wagon 14, and provide stability when traveling with loaded bales. The frame 70 further includes a closed end 78 normally oriented toward the tractor 10 (see FIG. 1), and an open end 80 into which the bales are loaded. The wagon 14 operates in a similar fashion as the fork 12, but the wagon 14 backs into piles of bales instead of driving forward into them. The frame can be seen to include a left side guiding plate 82 and a right side guiding plate 84 extending upwardly from the left side rail 126 and the right side rail 130, respectively. The guiding plates 82, 84 are inclined outwardly from the open end 80 and serve to guide piles of bales into the frame 70. In this embodiment, they thus replace the rollers 42 which were used on the outer tines 26 and 30 of the fork (FIG. 2) to contribute in guiding the bales between the cooperating tines (26 and 28 or 28 and 30).

Using the wagon 14 and the fork 12 as depicted in FIG. 1, a tractor operator can make an appropriate array of piles of stacked bales of a predetermined height and arranged with a predetermined number of bales in depth, using the fork 12, and then back into the array of bales with the wagon lowered at a first height h₁ (the wagon being elevated and lowered with the wheel systems 74 and 76), and once in correct position, lift the entire array of bales. The operator may then transport the entire array of bales to a distant location. To deposit the array of bales, once at the destination, the operator lowers the wagon to a second height h₂, which is preferably lower than the height h₁. This results in the shutters opening under the upward pressure from the bales, and the bales being somewhat freed from the flaps, which minimizes damage to the bales when the tractor 10 and wagon 14 retract the rails 126, 128, 130 from the array of bales by advancing and letting the array of bales out the open end 80 of the wagon 14.

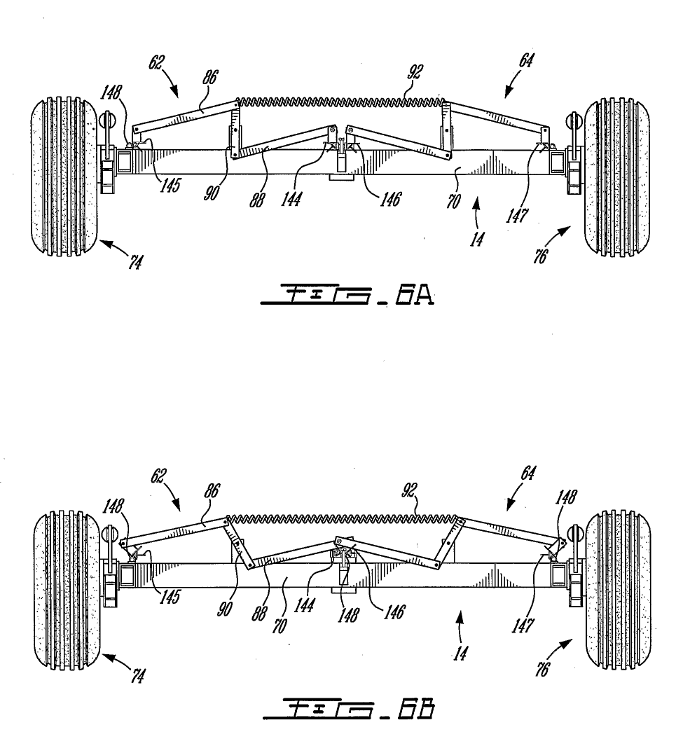

Turning to FIGS. 6A and 6B, one optional linkage system will be described in further detail. In one embodiment of the invention, the wagon 14 has a linkage system including left and right linkages 62, 64 which is preferably also used in the fork 12 (FIG. 2). The left side linkage 62 links the left side shutter 145 to the left side shutter 144, and the right side linkage 64 is a mirror image of the left side linkage 62 for the right side shutters 146, 147. The linkage 62 includes three linking members: a left side linking member 86, a right side linking member 88, and a central linking member 90. The left side linking member is pivotally connected at one end with the left side shutter 145, at a point off-center with the hinges 148, and is connected at the other end with one end of the central linking member 90. The central linking member 90 is connected at its other end to one end of the right side linking member 88, and is pivotally mounted to the frame 70 of the wagon 14 at its center. The light side linking member 88 has its other end mounted to the left side shutter 144 at a point off-center with its hinge 148 from the same distance that the left side linking member 86 is off-center with the hinge 148 of the left side shutter 145. In this embodiment, the left and right side linking members 86, 88 are of equal length. This configuration provides an equal amount of pivoting of the cooperating shutters 144 and 145, although in inverse or mirror angular direction. In the depicted embodiment, the shutters position themselves in the closed position depicted in FIG. 6A by default, under their own weight, but in an alternative embodiment, the shutters can be maintained in a somewhat open position by default. In the depicted embodiment, an optional spring 92 is added between the left side linkage 62 and the right side linkage 64 and in addition to the weight of the shutters, the spring 92 exerts an additional force tending to close the shutters by default. In FIG. 6B, the shutters 144, 145, 146, 147 are shown in open position, with the spring pulling them into closed position. In alternatives to this embodiment, the linkages are manually or mechanically operated, and the spring can be assembled in a manner to function inversely, countering the weight of the shutters, and maintaining the shutters in a somewhat open position by default.

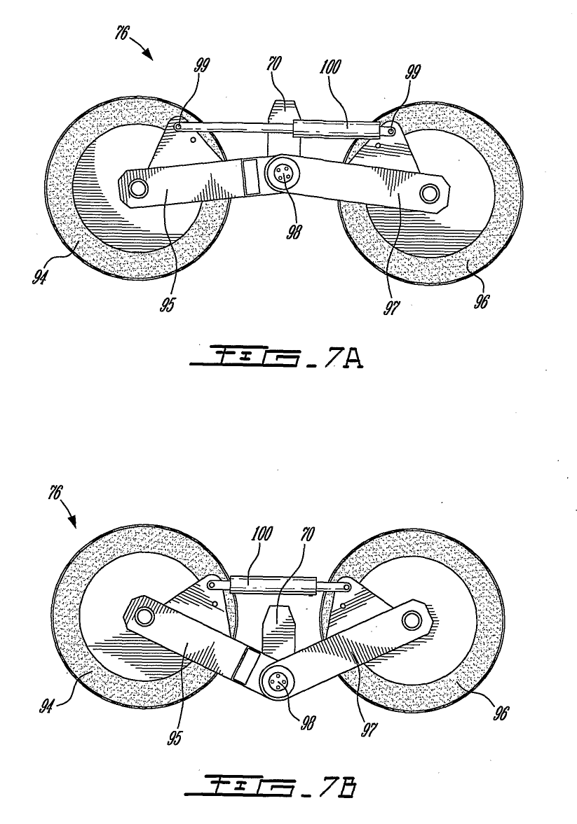

Turning now to FIGS. 7A and 7B, one tandem wheel system 76 is depicted in better detail. In one embodiment, the tandem wheel system 76 includes a front wheel 94, and a rear wheel 96. The axle of the front wheel 94 is pivotally connected to a shaft 98 via a front link member 95, and the axle of the rear wheel is pivotally connected to the same shaft 98 via a rear link member 97. The shaft 98 is connected to the frame 70 of the wagon 14 (FIG. 1). The front link member 95 and the rear link member 97 both have an extension 99 which extends transversally away from an imaginary axis connecting the wheel axle to the shaft 98. An extending member 100, such as a hydraulic piston, connects the extensions 99 of the front and rear link members 95, 97 in a manner that contraction of the extending member 100 lowers the shaft 98 and the frame 70 of the wagon 14 away from the extending member 100 and towards the ground where the front 94 and rear 96 wheels rest, whereas the extension of the extending member raises the shaft 98 and the frame 70 of the wagon 14 toward the extending member 100 and away from the ground where the front 94 and rear 96 wheels rest. In FIG. 7A, the wheel system 76 is shown in raised position, with the frame away from the ground, in a position to transport an array of bales, whereas in FIG. 7B, the wheel system 76 is shown in lowered position, with the frame close to the ground, in position to engage an array of bales.

The embodiments of the invention described above are intended to be exemplary only. Those skilled in the art will appreciate that many adaptations, alternative embodiments, and modifications may be made to the embodiments described without departing from the general principles of the invention. For example, although the embodiments described are well adapted to manipulate square bales, the invention can alternatively be used to manipulate round bales or bales having any other shape known to those skilled in the art, with or without adaptation. Therefore, the scope of the invention is intended to be limited solely by the scope of the appended claims.

1. A bale handling apparatus having at least two parallel support members for engaging individual bales and movable in a generally vertical direction, the support members being separated by a distance which generally corresponds to a width of a bale to be handled, the bale handling apparatus characterized in that each support member has a flap defining a longitudinal edge, the flaps being pivotable between a closed position where each edge extends towards the edge of the other flap and where the flaps can cooperate in lifting a bale engaged between the support members upon elevating the support members, and an open position where the bale is substantially freed from the flaps to allow longitudinal disengagement of the flaps from the bale.

2. The bale handling apparatus of claim 1 wherein the flaps are hingedly mounted along the support members and are free to pivot upwardly from the closed position and a stopper is provided to prevent the flap from pivoting downwardly from the closed position even under pressure from the weight of a bale.

3-5. (canceled)

6. The bale handling apparatus of claim 1 wherein the edges of the flaps define a cycloid shape to minimize damage to the bale from longitudinal disengagement therefrom.

7. The bale handling apparatus of claim 1 wherein the support members have a free end and a fixed end, and wherein the flaps can longitudinally engage a bale therebetween from the free end towards the fixed end.

8-9. (canceled)

10. The bale handling apparatus of claim 1 wherein at least two cooperating flaps are connected to one another by a linkage, the linkage maintaining an inversely corresponding pivoting angle of the two cooperating flaps.

11. The bale handling apparatus of claim 1 wherein the bale handling apparatus is a fork for lifting and transporting individual bales.

12. The bale handling apparatus of claim 11 wherein the fork includes an attachment rod having a hook, the attachment rod being connected to the fixed end of the support members and oriented perpendicularly from the support members; the hooks being adapted to engage the fork onto a manipulating component of a tractor.

13. The bale handling apparatus of claim 11 wherein the fork further includes at least one support rod connected to the fixed end of the support members and oriented perpendicularly from the support members, whereby the support rod limits the relative horizontal displacement of the bale with respect to the fork.

14. The bale handling apparatus of claim 1 including two tandem wheel systems, each tandem wheel system being connected to a distinct support member, each tandem wheel system including a first and a second wheels, the first and the second wheel each having its axle pivotally connected to a common shaft by a first and a second link members, respectively, each link member having an extension being defined away from an imaginary axis connecting the wheel axle to the shaft, the extension of the first link member being connected to the extension of the second link member by an extending member for pulling and pushing the extensions towards and away from each other, whereby the support members are elevated and lowered by the pulling and pushing action of the extending members of each tandem wheel system.

15. A method of handling a bale comprising:
freeing at least one bale including
lowering two parallel support members having cooperating flaps in a closed position, the flaps supporting a bale engaged therebetween, until the bale touches the ground;
pivoting the cooperating flaps on the support members into an open position to substantially free the bale from the flaps; and
longitudinally disengaging the pivoted flaps from the bale.

16. The method of claim 15 further comprising:
lifting at least one bale including
pivoting the cooperating flaps on the support members into an open position;
lowering the support members with the flaps in open position alongside the bale;
pivoting the flaps of the lowered support members into a closed position with the bale engaged therebetween; and
raising the support members and the two cooperating flaps in closed position with the flaps sustaining the engaged bale, thus lifting the bale.

17. The method of claim 15 wherein the cooperating flaps are pivoted by the bale.

18. A bale handler comprising:
a mobile frame including at least a pair of parallel spaced apart support members, the support members capable of being jointly raised and lowered, and defining a bale reception area therebetween;
at least two cooperating flaps, one on each member, each flap having a free edge and being upwardly pivotable between
a closed position of the flaps in which each flap extends towards the bale reception area, whereby the cooperating flaps can engage and support the weight of at least one bale, and
an open position where the bale is substantially free from the flaps.

19. The bale handler of claim 18 wherein the flaps are part of a shutter that is L shaped in cross section, the other part of the shutter defining a stopper which keeps the flaps from pivoting downwardly from the closed position by abutment with the support member.

20. The bale handler of claim 18 defining a fork, wherein the support members define tines of the fork, and wherein the tines of the fork are connected together at a fixed end thereof and are cantilevered.

21. The bale handler of claim 18 defining a wagon including the mobile frame, the mobile frame connecting the support members together, the wagon further comprising two tandem wheel systems, each tandem wheel system being connected to the mobile frame at an opposite side of the wagon, each tandem wheel system including front and rear wheels, the front and the rear wheels each having axles pivotally connected to a common shaft by a front wheel and a rear wheel link members, respectively, each link member having an extension being defined offset from an axis connecting the wheel axle to the shaft, the extension of the first link member being connected to the extension of the second link member by a third link member, the third link member being actuatable for pulling and pushing the extensions towards and away from each other, whereby the support members and the cooperating flaps are to be raised and lowered by the pulling and pushing action of the third link member of each tandem wheel system.

22. The bale handler of claim 18 wherein the edges of the flaps define a generally cycloid shape.

23. The bale handler of claim 18 wherein one end of the flaps is beveled to ease longitudinal engagement of a bale.

24. The bale handler of claim 18 further comprising means for linking the cooperating flaps together in a manner for maintaining the angle of the first cooperating flap a mirror image of the angle of the second cooperating flap along a mirror plane defined perpendicularly, halfway between the first and second cooperating flaps.

25. The bale handler of claim 18 wherein the flaps are freely pivotable into the open position, and wherein each flap includes one or more fins longitudinally disposed along the flap and being defined at an angle downwardly oriented from the flap in a manner that an engaged bale pivots the flaps towards the open position upon lowering of the flaps along the sides of the bale, and that the fins subsequently further pivot the flaps towards the open position by engagement with the bale.
